(19) United States
(12) Patent Application Publication
(10) Pub. No.: US 2007/0012533 A1
(43) Pub. Date: Jan. 18, 2007

(54) Hydraulic system bleed device

(75) Inventor: Robert Whitt, Cincinnati, OH (US)

Correspondence Address: WILLIAM H. HOLLIMON;MOYLE, FLANIGAN, KATZ, RAYMOND & SHEEHAN, P.A., 118 N. GADSDEN STREET, TALLAHASSEE, FL, 32301, US

(73) Assignee: R. Whitt 1 Enterprises LLC

(21) Appl. No.: 11/183,929

(22) Filed: Jul. 18, 2005

(51) Int. Cl. B60T 11/00

(52) U.S. Cl. 188/352

(57) ABSTRACT

A hydraulic system bleed device for applying pressure to a pedal associated with a hydraulic system so as to permit the hydraulic system to be bled by a single person. The hydraulic system bleed device includes a cylinder with an internal compression spring, extension shafts extendable from within the cylinder, a telescoping extension shaft, a pedal attachment assembly, a steering wheel attachment assembly, and a lever for compressing the cylinder spring to provide an urging force against a hydraulic system pedal.

### FIELD OF THE INVENTION

The present invention relates to tools used for bleeding a hydraulic system. Specifically, the present invention relates to a hydraulic system bleed tool which simplifies the bleeding process and allows for a single person to accomplish the bleeding process.

### BACKGROUND OF THE INVENTION

Hydraulic systems are commonly used in vehicles and other equipment in various applications such as brake systems, clutch systems, and auxiliary systems. Hydraulic systems work because the hydraulic fluid within these systems in non-compressible. However, maintenance on these systems typically requires that the hydraulic system be opened to the atmosphere such that air is introduced into the system. Because air is compressible, introduction of air into a hydraulic system comprises the operation of such hydraulic systems because pressure applied to the hydraulic fluid must first compress the air trapped in the system. Thus, at the conclusion of such maintenance activities, it is essential to the proper operation of such systems that all air be removed from the hydraulic system.

This process is generally known as “bleeding” the system, a process by which air is removed from the hydraulic system. This process is well known and is most frequently used in association with maintenance on braking systems on all manner of vehicles and equipment.

Presently, the simplest and most cost effective method of bleeding a brake system is to open bleed ports or fittings in the brake system and then apply pressure to the system by depressing the brake pedal. However, this generally requires the labor of two persons; one to depress the brake pedal, and the second to monitor the flow of brake fluid through the bleed ports. Because two persons are needed to perform this process, the labor costs associated with this type of maintenance are effectively doubled. Thus, there is a need in the art for a device that allows a single person to bleed a hydraulic system and thereby reduce the labor costs associated with this maintenance activity.

### SUMMARY OF THE INVENTION

The present invention provides the art with a hydraulic system bleed device that allows a single person to bleed a hydraulic system. The hydraulic system bleed device of this invention comprises a spring loaded cylinder which is positionable between a vehicle steering wheel and a brake pedal. Once positioned, operation of a compression lever compresses the cylinder spring applying a downward force on the connected pedal. This downward force pressurizes the hydraulic system.

The hydraulic system bleed device of the present invention allows a single person to bleed a hydraulic system. After the tool is positioned and compressed, the bleed ports may be opened to allow entrained air to escape. A single mechanic can perform this maintenance because a second person is no longer needed inside the vehicle to manually apply pressure to the hydraulic system being bled.

It is an object of the present invention to provide a hydraulic system bleeding device that allows one person to bleed a hydraulic system. Another object of the present invention is to provide simple and effective connections that allow the hydraulic system bleed device to easily be attached to pedals of various shapes and sizes, and to steering wheels of various dimensions and configurations. It is another object of the invention to provide a hydraulic system bleed device that uses quick connect type fittings to facilitate placement and removal. It is another object of the present invention to provide a hydraulic system bleed device that is easily pressurized by one person located outside of a vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DRAWINGS

These and other features, aspects, and advantages of the present invention will become better understood with regard to the following description, appended claims, and accompanying drawings wherein:

FIG. 1 is an isometric view of the present invention;

FIG. 2 is an isometric view of the steering wheel attachment assembly of the present invention

FIG. 3 is an exploded view of the pedal attachment assembly of the present invention;

FIG. 4 is a sectional view of the main cylinder of the present invention in an unloaded condition;

FIG. 5 is a sectional view of the main cylinder of the present invention in a loaded condition.

FIG. 6 is a partial sectional view of an embodiment of the invention employing an offset J-hook.

### DESCRIPTION

The following description of the preferred embodiment(s) is merely exemplary in nature and is in no way intended to limit the invention, its application, or uses.

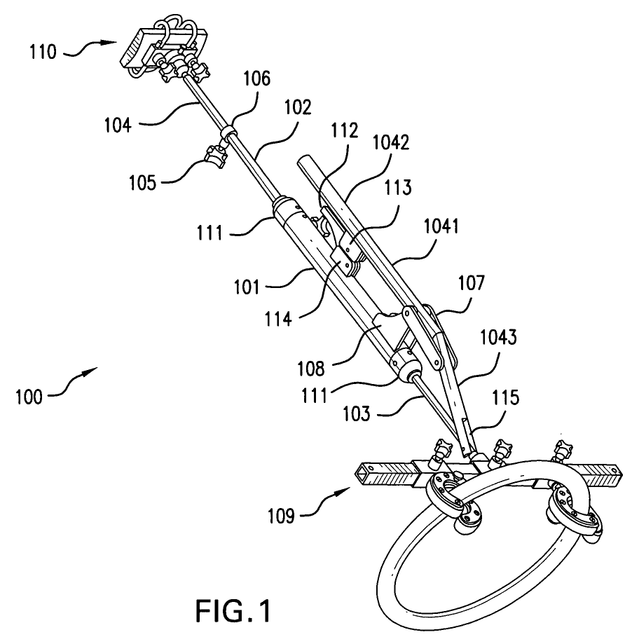

Referring now to the drawings in which like reference numbers designate like or corresponding parts throughout the several views, there is shown in FIG. 1 a hydraulic system bleed device which is designated generally by the reference number 100, hydraulic system bleed device (“HSBD”) 100 is comprised of main cylinder 101, cylinder endcaps 111, compression lever 104, outboard extension shaft 103, inboard extension shaft 105, nesting extension shaft 104, steering wheel attachment assembly 109, and pedal attachment assembly 110.

Main cylinder 101 is preferably a hollow, aluminum tube designed to securely accommodate a compression spring (not shown in FIG. 1) used to pressurize a hydraulic system. Main cylinder 101 further includes cylinder end caps 111 which are inserted into the inboard (pedal attachment assembly end) and outboard (steering wheel attachment assembly end) of main cylinder 101. Bracket 108 extends perpendicularly from the exterior of main cylinder 101 and is located at the outboard end of main cylinder 101. Lock support 114 extends perpendicularly from the exterior of main cylinder 101 and is located just inboard of the center of main cylinder 101.

End caps 111 are preferably constructed from hollow aluminum tube for slidingly receiving inboard extension shaft 102 and outboard extension shaft 103. End caps 111 have a first outer diameter that is slightly smaller than the inner diameter of main cylinder 101 and extending for a length sufficient to slidingly engage with main cylinder 101; a square shoulder rising to a second diameter that is approximately equal to the outer diameter of main cylinder 101; and a radiused shoulder that ends in a third inner diameter that is slightly larger than the outer diameter of inboard extension shaft 103 and outboard extension shaft 102. End caps 111 are fastened to main cylinder 101 by pins, screws, or the like.

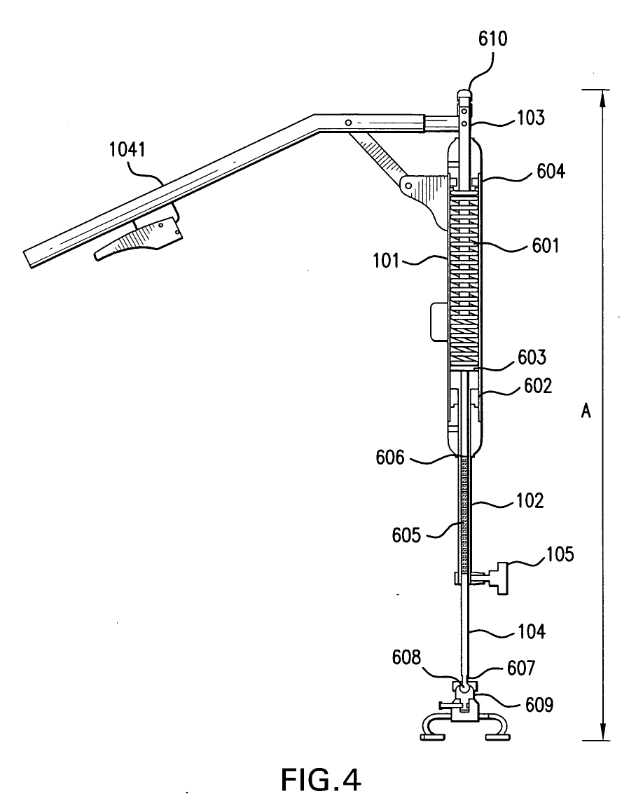

Outboard extension shaft 103 extends from the interior of main cylinder 101 and is connected to wheel attachment assembly 109 by a spring detent, quick-connect, type fitting. As shown in FIG. 4, outboard extension shaft 103 includes fitting 610 at its outboard end. Fitting 610 is connected to outboard extension shaft 103 by a pin or screw and includes a reduced diameter section terminating in a full diameter section. Outboard extension shaft 103 is free to move axially within main cylinder 101. Similarly, inboard extension shaft 102 extends from the interior of main cylinder 101 and moves axially within main cylinder 101. Inboard extension shaft 102 has an inner diameter that is slighter larger than the outer diameter of nesting extension shaft 104, allowing nesting extension shaft 104 to slidingly engage, and move axially within and telescope from inboard extension shaft 102. The amount of engagement of nesting extension shaft 104 within inboard extension shaft 102 is fixable via clamp 106 and locking screw 105. The inboard end of nesting extension shaft 104 includes a reduced diameter shoulder 607 terminating in a spherical ball 608. Spherical ball 608 is received by socket 609 and the resulting ball-in-socket connection allows for and accommodates any misalignment between nesting extension shaft 104 and socket 609. Socket 609 includes a nipple on its outboard end that is received by nesting extension shaft connector 403.

Compression lever 1041 is preferably constructed of aluminum tubing and attaches to outboard extension shaft 103 just inboard of fitting 610. The attachment of compression lever 1041 to outboard extension shaft 103 is preferably a pinned connection perpendicular to the axis of outboard extension shaft 103. Compression lever 1041 includes a first section 1042 that is approximately the length of main cylinder 101, and an offset section 1043 that extends from the outboard end of first section 1042 at approximately a 30 degree angle. Offset section 1043 terminates at a connection to outboard extension shaft 103 and includes slot 115 which allows rotation of compression lever 1041 about outboard extension shaft 103. Link 107 extends between link support 108 and the inboard end of offset section 1043 of compression lever 1041. Preferably, link 107 is comprised of a pair of flat plates. Link support 108 is comprised of a pair of parallel flanges extending radially from main cylinder 101. Compression lever 1041 is movable between a first position (as shown in FIG. 1) where first section 1042 is substantially parallel to main cylinder 101 and a second position (as shown in FIG. 4) where second section 1043 is substantially perpendicular to main cylinder 101.

Compression lever 1041 further includes trigger support 113 which holds trigger 112 and is positioned to engage lock support 114 when compression lever 1041 is positioned in its first position, substantially parallel to main cylinder 101. Trigger support 113 is comprised of a pair of parallel flanges separated by a space sufficient to receive trigger 112 and extending radially from compression lever 1041 towards main cylinder 101. Lock support 114 is likewise comprised of a pair of parallel flanges extending radially from main cylinder 101 towards compression lever 1041 and includes a receiving pin transverse to the parallel plates of lock support 114. Trigger support 113 and lock support 114 are positioned to be substantially aligned when compression lever 1041 is in its first position. Trigger 112 is connected between the parallel flanges of trigger support 113 through a pinned connection transverse to the parallel plates of trigger support 113, such that trigger 112 may selectively engage the locking pin included in lock support 114.

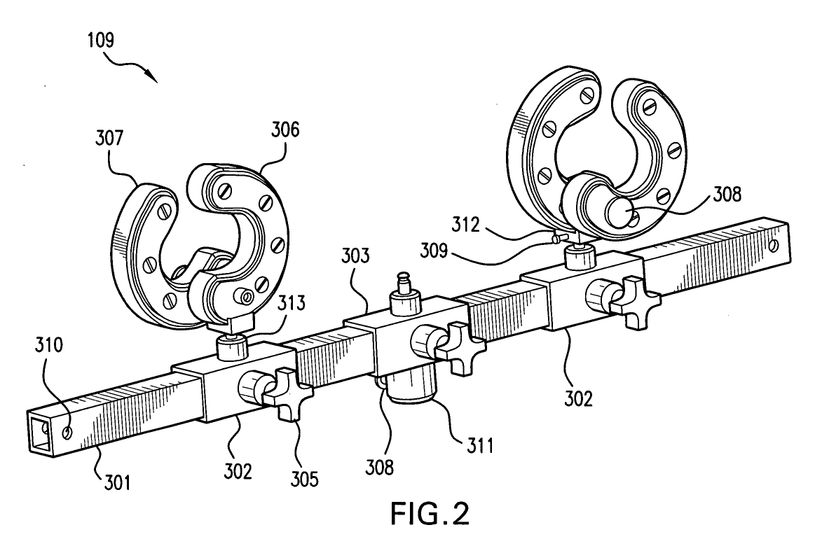

Referring to FIG. 2, an isometric view of the steering wheel attachment assembly 109 is shown. Main beam 301 is preferably constructed of square structural tubing, but may be constructed of other structural shapes that are sufficiently strong and rigid. Center slide 303 slidingly engages main bean 301 and is composed of square structural tubing with an inside height and width slightly larger than the outside height and width of main beam 301. Once positioned on main beam 301, lock screw 305 may be tightened to assert a frictional force against main beam 301 that prevents movement of center slide 303 along main beam 301. Center slide 303 further includes outboard extension shaft connector 311 which is structurally connected, preferably by welding, to center slide 303. Outboard extension shaft connector 311 is a quick connect fitting that utilizes spring detent 308 to capture outboard extension shaft 103 (not shown) and allow for a rapid and secure connection. A slide 302 is slidably engaged with main beam 301 on both sides of center slide 303. Each slide 302 includes a two piece clamp 306. Clamp 306 is composed of two opposed U-shaped retainers that pivot about a pinned connection at the end of the “U” closest to main beam 301. This connection employs a spring detent 308 which selectively allows pivoting of the U-shaped retainers. The inside, engaging surface of each U-shaped connector is covered by pad 307 which is preferably a foam type pad that accommodates a secure connection to a steering wheel (not shown) without causing damage to the surface of the steering wheel (not shown). Clamp 306 includes clamp connector 312, which is a quick fit connector that mates with clamp quick connect 313 which is attached to slide 302. Lock pin 309 is spring loaded and engages with a reduced diameter portion of clamp quick connect 313 to secure clamp 306 to slide 302. Clamp 306 is positioned to receive a steering wheel (not shown) by retracting spring detent 308, separating the U-shaped retainers, and moving steering wheel attachment assembly 109 into place. Once positioned, the U-shaped retainers are designed to securely retain a steering wheel (not shown), and the engagement of spring detent 308 prevents movement of the U-shaped retainers.

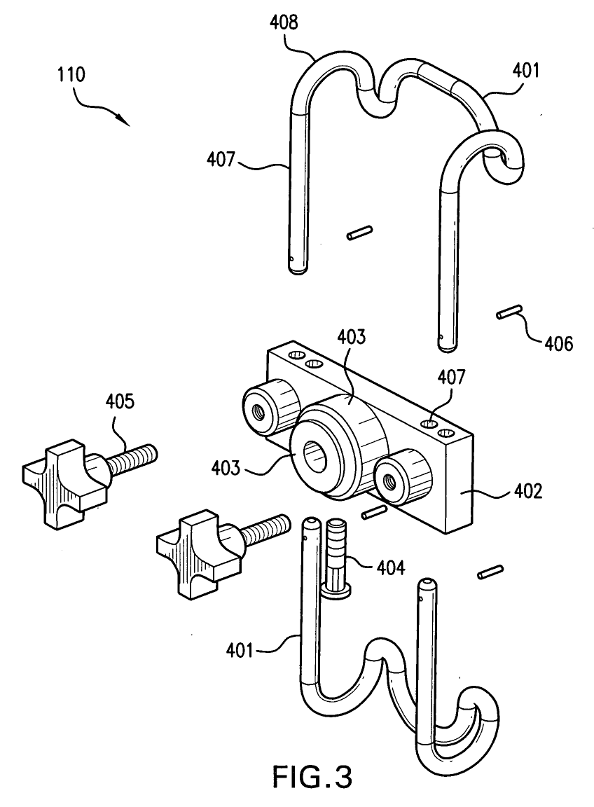

Referring to FIG. 3, an exploded view of pedal attachment assembly 110 is shown. Pedal attachment assembly 110 is comprised of pedal clamp support 402 and a pair of pedal clamps 401. Pedal clamp support 402 is preferably rectangular in shape and formed from a metal or structural plastic material. Pedal clamp support 402 includes nesting extension shaft connector 403, which is a quick-connect type fitting further including spring detent 404, which is preferably welded to pedal clamp support 402, or integrally formed into pedal clamp support 402. Pedal clamp support 402 includes through holes 407 which are transverse to the longitudinal axis of pedal clamp 402 and slidingly receive pedal clamps 401. Pedal clamps 401 include a pair of parallel legs 407 that slidingly engage pedal clamp support 402 through holes 407, and an offset section 408 that extends transversely between parallel legs 407 and provides a receiving offset to capture a vehicle pedal (not shown). Pedal clamps 401 are inserted through pedal clamp support 402 in an opposed fashion. Once positioned through pedal clamp support 402, limit pins 406 are inserted through parallel legs 407 to retain each clamp 401 and limit the sliding travel of parallel legs 407 within pedal clamp support 402. In operation, pedal clamps 401 are extended to the limit of their travel to receive a vehicle pedal (not shown). Once the vehicle pedal is received, each clamp 401 is slid inward to capture a vehicle pedal. Once captured, lock screws 405 are tightened to prevent any further movement of clamps 401.

Each pair of clamps 306 are moveable from a first position (not shown)

Referring to FIG. 4, a sectional view of HBSD 100 in the unloaded condition is shown. Compression lever 1041 is shown in its second position. In this position, outboard extension shaft 103 is primarily disposed within main cylinder 101. Spring 601 is unloaded (not compressed) and is disposed between spring stop and shaft guide 604 which is internal to main cylinder 101 and positioned proximate to the outboard end of main cylinder 101, and spring disc 603 which is connected to the outboard end of inboard extension shaft 102. The axial alignment of outboard extension shaft 103 within main cylinder 101 is maintained by spring stop and shaft guide 604 and the axial alignment of inboard extension shaft 102 is maintained by bearing 602 which is disposed interior to main cylinder 101 and located proximate to the inboard end of main cylinder 101. Inboard extension shaft spring 605 is disposed within inboard extension shaft 102 between spring stop 606 and the outboard end of nesting extension shaft 104. Distance A is the distance from a vehicle's steering wheel to a vehicle's brake pedal.

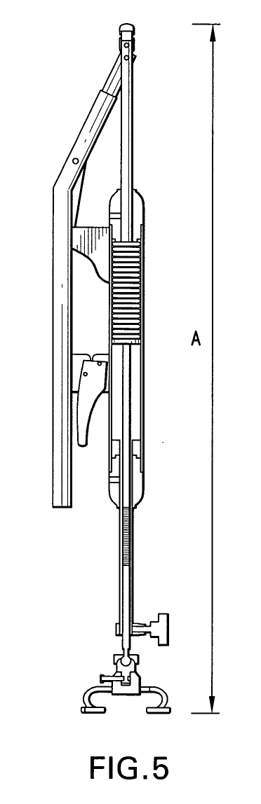

Referring to FIG. 5, a sectional view of HBSD 100 in the loaded condition is shown. Compression lever 1041 is shown in its first position and trigger 112 is engaged with trigger lock 114. In this position, outboard extension shaft 103 is primarily disposed without main cylinder 101. Because distance A is substantially constant, the extension of outboard extension shaft outboard from main cylinder 101 causes main cylinder 101 to move inboard and spring 601 is compressed between shaft guide and spring stop 604 and spring disc 603 and spring 605 is compressed between spring stop 606 and the outboard end of nesting extension shaft 104. The combined loading of spring 601 and spring 605 provides an urging force against pedal attachment assembly 110 that pressurizes a vehicle's hydraulic system.

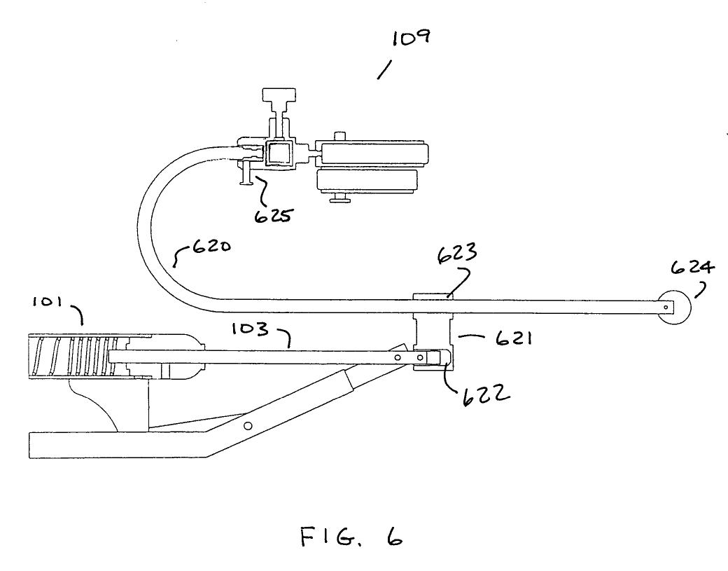

Referring to FIG. 6, an alternative embodiment of the present invention is shown. In this embodiment, steering wheel attachment assembly 109 is offset from main cylinder 101 by J-hook 620 and offset slide 621. Offset slide 621 includes a recess 622 adapted to receive outboard extension shaft 103 and passageway 623 adapted to slidingly engage J-hook 620. Offset slide 621 further includes a screw lock 105 (not shown) which selectively locks the position of J-hook 620 within offset slide 621. J-hook 620 is a curved rod substantially in the shape of the letter “J.” The outboard end of J-hook 620 is adapted to receive handle 624 which facilitates position adjustment of J-hook 620 within offset slide 621. The inboard end of J-hook 620 is adapted to connect to steering wheel attachment assembly 109 through spring detent quick connect 625. This embodiment allows for additional compensation in effective overall length of HBSD 100 (through the positioning of J-hook 620 within offset slide 621) and additional compensation for alignment between pedal attachment assembly 110 and steering wheel attachment assembly 109.

Operation

HSBD 100 allows for the positive, secure but adjustable, connection between a vehicle's steering wheel and brake pedal and provides a simple mechanism whereby a single person can pressurize a hydraulic system to effectuate the process of bleeding air entrained in that hydraulic system. In operation, steering wheel attachment assembly 109 and pedal attachment assembly 110 are first attached to a vehicle's steering wheel and brake pedal, respectively.

Once the steering wheel attachment assembly is positioned, lock screws 305 are tightened to secure and fix the position of slides 302 and center slide 303. Pedal attachment assembly 110 is connected to the appropriate pedal by loosening pedal clamp locks 405, extending pedal clamps 401 to the limit of their travel, positioning pedal clamps 401 around the pedal selected, retracting pedal clamps 401 into pedal clamp support 402 until the selected pedal has been securely engaged, and tightening pedal clamp locks 405.

Following placement and positioning of steering wheel attachment assembly 109 and pedal attachment assembly 110, HSBD 100 is connected between steering wheel attachment assembly 109 and pedal attachment assembly 110 in the unloaded condition as shown in FIG. 4. Although length A is approximately constant for a given vehicle, it will vary between vehicles. To accommodate this difference, lock screw 105 may be loosened to allow movement of nesting extension shaft 104 within inboard extension shaft 102 to allow placement of HSBD 100 with spring 601 in an unloaded condition. Alternatively, lock screw 105 controlling movement of J-hook 620 within offset slide 621 may be loosened to allow inboard/outboard movement of J-hook 620. Once HSBD 100 is positioned, lock screw 105 is tightened, fixing the telescoped length of nesting extension shaft 104 and/or the final positioning of J-hook 620. Preferably, HSBD is positioned with compression lever 1041 extending outward from a vehicle steering wheel towards a vehicle driver door, thereby allowing a technician external to the vehicle to easily reach compression lever 1041. The technician then moves compression lever 1041 to its second position and secures trigger 112 to trigger lock 114. Spring 601 is now loaded and applies an urging force against a captured vehicle pedal.

Although the illustrative embodiments of the present invention have been described herein with reference to the accompanying drawings, it is to be understood that the invention is not limited to those precise embodiments, and that various other changes and modifications may be affected by one skilled in the art without departing form the scope or spirit of the invention. All such changes and modifications are intended to be included within the scope of the invention as defined by the appended claims.

What is claimed is:

1. A hydraulic system bleed device comprising:
a. an elongated cylindrical member having a first end and a second end;
b. a first extension shaft extending axially from an interior of said cylindrical member through said first end of said cylindrical member, said first extension shaft capable of moving from a first position wherein said first extension shaft is primarily disposed within said interior of said cylindrical member, to a second position wherein said first extension shaft is primarily disposed external to said interior of said cylindrical member;
c. a second extension shaft extending axially from said interior of said cylindrical member through said second end of said cylindrical member, said second extension shaft capable of moving from a first position wherein said second extension shaft is primarily disposed within said interior of said cylindrical member, to a second position wherein said second extension shaft is primarily disposed external to said interior of said cylindrical member
d. a first spring disposed within said cylindrical member between said second extension shaft and said first end of said cylindrical member for urging said second extension shaft towards said second position of said second extension shaft;
e. an adjustment shaft mounted telescopically inside said second extension shaft, said adjustment shaft having a first end disposed within said second extension shaft and a second end external to said second extension shaft and having a reduced diameter shoulder extending to a spherical ball at a terminus of said second end;
f. a second spring mounted within said second extension shaft and mounted between a spring stop disposed within said second extension shaft and said adjustment shaft for urging said adjustment shaft away from said cylindrical member;
g. a socket for selectively receiving said spherical ball, said socket attached to a pedal clamp, said pedal clamp configured to selectively engage and secure a hydraulic system pedal;
h. locking means for selectively fixing a telescoped length of said adjustment shaft;
i. a steering wheel clamp configured to selectively engage said first extension shaft and further configured to selectively engage a steering wheel;
j. a lever pivotably connected to said cylindrical member and said first extension shaft whereby movement of said lever moves said first extension shaft between said first extension shaft first position and said first extension shaft second position; and
k. means for locking said lever in a fixed position.

2. The hydraulic system bleed device of claim 1 wherein said steering wheel clamp comprises:
a. a beam;
b. at least one clamp assembly slidably engaged with said beam;
c. means for selectively fixing the position of said clamp assembly upon said beam; and
d. means for selectively coupling said steering wheel clamp to said first extension shaft.

3. The hydraulic system bleed device of claim 2 wherein said clamp assembly comprises:
a. a pair of opposed, U-shaped clamps, each of said clamps having a transverse opening through a first end of said clamps,
b. a common shaft extending through said transverse openings and upon which said clamps are rotatably mounted; and
c. means for selectively allowing the rotation of said clamps about said shaft.

4. A hydraulic system bleed device comprising:
a. an elongated cylinder having a compression spring disposed within said elongated cylinder;
b. a first extension shaft partially disposed within said elongated cylinder and extendable from a first end of said elongated cylinder;
c. a second extension shaft partially disposed within said elongated cylinder and extendable from a second end of said elongated cylinder, said second extension shaft having a first end disposed within said elongated cylinder and bearing against said compression spring and a second end disposed external to said elongated cylinder;
d. a lever attached to said first extension shaft and said elongated cylinder, said lever moveable between a first position wherein said first extension shaft is primarily disposed within said elongated cylinder, and a second position, wherein said first extension shaft is primarily disposed without said elongated cylinder;
e. means for selectively securing said lever to said elongated cylinder when said lever is in said second position;
f. a telescoping extension shaft partially disposed within said second extension shaft and urged to telescope from said second extension shaft by a compression spring disposed within said second extension shaft, said telescoping extension shaft terminating in a ball and socket connector at a distal end;
g. means for fixing a telescoped length of said telescoping extension shaft;
h. a pedal clamp connected to said ball and socket connector;
i. a j-hook slidingly connected to a distal end of said first extension shaft; and
j. a steering wheel clamp connected to an inboard end of said j-hook.

5. The hydraulic system bleed device of claim 4 wherein said steering wheel clamp comprises:
a. a beam;
b. at least one clamp assembly slidably engaged with said beam;
c. means for selectively fixing the position of said clamp assembly upon said beam; and
d. means for selectively coupling said steering wheel clamp to said first extension shaft.

6. The hydraulic system bleed device of claim 4 wherein said clamp assembly comprises:
a. a pair of opposed, U-shaped clamps, each of said clamps having a transverse opening through a first end of said clamps,
b. a common shaft extending through said transverse openings and upon which said clamps are rotatably mounted; and
c. means for selectively allowing the rotation of said clamps about said shaft.
